(19) United States
(12) Patent Application Publication
(10) Pub. No.: US 2005/0214553 A1
(43) Pub. Date: Sep. 29, 2005

(54) Metal/polymer laminates, a method for preparing the laminates, and structures derived therefrom

(75) Inventors: Bill Yannetti, Chesapeake, VA (US); Joe Rudisi, Virginia Beach, VA (US); Dave Kearney, Newport News, VA (US); Guerry L. Grune, Virginia Beach, VA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI CHEMICAL AMERICA, INC., Chesapeake, VA (US)

(21) Appl. No.: 10/809,514

(22) Filed: Mar. 26, 2004

(51) Int. Cl. B32B 27/36

(52) U.S. Cl. 428/461

(57) ABSTRACT

A metal/polymer laminate containing at least two metal layers and at least one core polymer layer laminated between two metal layers. The presence of a silane of formula (I) in the core polymer layer, on the surface of the metal layers or in a separate adhesive layer improves the delamination resistance of the metal/polymer laminate:
R¹_{y}R²ₓSi(OR³)_{4-x-y} (I)
wherein R² is a C₁₋₁₂-hydrocarbon group containing one or more atoms selected from the group consisting of N, S and O, 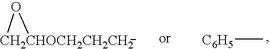
R³ is H—, C₁₋₄-alkyl;
R¹ is a C₁₋₁₂ alkyl group that may be ethylenically unsaturated; x is an integer of 1 to 3; and y is an integer of 0 to 2.

### BACKGROUND OF THE INVENTION

1. Field of the Invention

The invention relates to a metal/polymer laminate having at least one silane-containing polymer layer between at least two metal layers and having good delamination resistance. The invention also relates to a process for manufacturing the metal/polymer laminate including bonding the polymer layer between the metal layers with or without an additional adhesive layer between the surfaces of the polymer layer and the metal layers. The invention also relates to articles such as building cladding, molded items and roofing tiles which are made from the metal/polymer laminate and exhibit desirable weathering performance and appearance properties.

2. Description of the Related Art

Various composite laminates (hereinafter metal/polymer laminates) are known wherein a metal sheet is laminated on a thermoplastic synthetic resin sheet (e.g., polymer layer). Such metal/polymer laminates are useful for a number of architectural applications because the composites combine light weight with high strength. These metal/polymer laminates may be used as finished surfaces for all or some portion of the interior or exterior surfaces of a building. Metal-resin composite laminates are desirable for use outdoors including signage for construction zones along streets and highways. The metal/polymer laminates must exhibit good weathering resistance with regard to corrosive outdoor environments including exposure to salt, and temperature and humidity changes experienced during outside exposure, and must further be capable of bending to a sharp angle without cracking of the laminate on the exposed exterior surface of the metal or delamination of the composite. The metal/polymer laminate must be capable of being cut to specified lengths, curved, molded, routed, sawn, filed, drilled, punched or sheared and fastened in order to complete fabrication of the desired item.

Laminates having a metal layer and a polymer layer are known for metals such as aluminum and zinc. Conventional metal/polymer laminates contain a polymer layer which is adhered to one or more metal layers through an adhesive film layer or a chemical layer applied to the metal layer. In a typical conventional metal/polymer laminate, five layers may be present, e.g., a first metal layer, an adhesive-containing polymer layer, a polymer layer, an adhesive-containing polymer layer, and a second metal layer.

U.S. Pat. Nos. 4,994,130; 4,762,882; and 6,365,276; describe metal/polymer laminates having at least an aluminum layer and a polymer layer where an adhesive layer is present between the metal and polymer surfaces.

Prior art laminates have included a single metal layer laminated to a single plastic layer. There exists a need for metal/polymer laminates having a sandwich structure in which one or more polymer layers or polymer layer and adhesive layers are present between two metal layers to provide composite structures wherein both the front and back exposed exterior surfaces of the metal/polymer laminate are metal.

An adhesive layer between any polymer layer and a metal layer may be necessitated by the polymer layer's incompatibility with the metal layer. Such incompatibility may result in low delamination resistance. In the absence of a conventional adhesive layer the polymer layer may have insufficient adherence to the metal layers and delamination (i.e., detachment of the polymer layer and metal layer) may occur, even under minimum stress.

A conventional adhesive layer may contain a compound which chemically bonds both the polymer layer and the metal layer, such as an adhesive or a glue. In conventional metal/polymer laminates the adhesive layer may be a distinct thin layer of a polymer adhesive that is compatible with or at least exhibits bonding characteristics with both the polymer layer and the metal surface layer, or may be an adhesive-containing polymer film layer. Conventional adhesives include polyurethane glues. In conventional metal/polymer laminates the adhesive layer allows the incompatible bonding surfaces of the polymer and metal layers to adhere to one another.

The requirement for a separate adhesive layer complicates the manufacturing process and increases the overall cost and complexity of the metal/polymer laminate.

While conventional metal/polymer laminates prepared from separate polymer, adhesive, and metal layers are known for metals such as aluminum and zinc, other metals such as copper have shown insufficient delamination resistance in corrosive environments, especially when subjected to a salt water immersion test.

The difference in adhesion compatibility between, for example, aluminum and copper may be a result of the difference in the oxidation surface of the metal. Aluminum tends to form an oxide layer (e.g., aluminum oxide) that is thin and continuous and does not build or change significantly upon exposure to environmental or chemical elements. Copper and some other metals, especially ferrous metals, may continue to further oxidize at the surface of the metal and thereby change the adhesion characteristics and surface chemistry of the metal layer. In particular, copper has a thinner less stable copper oxide (CuO) layer that may include complex oxides of copper and may continue to oxidize over time, especially in an oxidizing environment where UV light, salt water and oxygen are present.

Laminates of copper metal may be desirable in applications such as building cladding, for example roofing materials, to provide a means of covering a roof with a material that has the desirable characteristics of pure copper sheeting at a lower cost than pure copper while not sacrificing the strength and durability of the pure metal. Copper is especially desirable as a roofing material due to its ability to continue undergoing oxidation. The oxidized surface of a copper metal may take on a “green” appearance that is known as a patina. The patina is seen by many as a desirable decorative architectural feature. Cladding a roof with pure copper metal is expensive and may not positively influence the structural or mechanical characteristics of the roof. A metal/polymer laminate may however provide additional structural integrity to the roof at a lower overall cost.

### SUMMARY OF THE INVENTION

Accordingly, it is an object of the present invention to provide metal/polymer laminates wherein a polymer layer is present between two metal layers and at least one layer between the metal layers contains a silane.

It is another object of the present invention to provide a method for preparing a metal/polymer laminate having two metal layers separated by a polymer layer that includes bonding the polymer layer to the metal layers through a silane-containing polymer interlayer.

It is another object of the present invention to provide a metal/polymer laminate containing only three layers, including a polymer layer sandwiched between two metal layers and directly in contact with both metal layers.

It is another object of the present invention to provide a metal/polymer laminate containing a polymer layer between two adhesive layers where the adhesive layers are in contact with two metal layers and the polymer layer.

It is another object of the present invention to provide a metal/polymer laminate having two metal layers separating a polymer core layer and two polymer interlayers between each surface of the polymer layer and each surface of the metal layer where the interlayer contains a polymer material containing copolymerized units of an organofunctional silane.

It is another object of the present invention to provide a metal/polymer laminate having two metal layers separating a polymer core layer and two polymer interlayers between each surface of the polymer layer and each surface of the metal layer where the interlayer contains a polymer material containing an organofunctional silane dispersed therein.

It is a further object of the present invention to provide a process for preparing a metal/polymer laminate by applying a silane to the surfaces of two separate metal layers and contacting the silane-coated surfaces of the metal layers with a polymer layer.

It is a further object of the present invention to provide a metal/polymer laminate which oxidizes slowly on at least one surface to provide a decorative finish.

It is another object of the present invention to provide a copper-containing metal/polymer laminate exhibiting high delamination resistance.

These and other objects of the invention, which will become apparent in the below detailed description, are realized through the inventors' discovery that the inclusion of a silane type material dispersed in the matrix of the polymer layer of the metal/polymer laminate allows direct and strong adhesion between the polymer layer and a metal layer either directly or through a separate silane-containing polymer interlayer. The invention metal/polymer layer contains at least two metal layers (such as copper, steel, aluminum, zinc and titanium) bonded to a polymer layer (such as a polyethylene layer) and may further contain one or more interlayers between the polymer and metal layers.

### DETAILED DESCRIPTION OF THE PREFERRED EMBODIMENTS

The inclusion of a silane in the polymer layer of a metal/polymer laminate, the presence of the silane on a surface of the metal layer in contact with the polymer layer or the presence of a silane-containing interlayer between the polymer and metal layers improves the delamination resistance of the metal/polymer layer in corrosive environments.

In one embodiment of the invention a metal/polymer laminate contains only a first metal layer, an core layer of a polymer and a second metal layer where the polymer layer is present between the metal layers. The polymer layer contains a silane agent to provide greater adhesion between the metal surface and the polymer surface.

The metal layer is preferably copper although other metals which contain an oxidized metal surface such as, for example, aluminum, zinc, steel and titanium may also be used. The metal may have an untreated surface and may be used in as “as received” condition from a foundry or the surface may be treated by applying a primer layer or anodizing the metal surface before contacting the surface of the metal layer with the polymer layer or the silane. The treatment of the metal layer may include pickling prior to being placed in contact with the polymer layer. For example, the surface of anodized metal surfaces may be sealed by immersion in boiling de-ionized water, sodium bichromate, nickel acetate solutions or steam, thus making the anodized coating on the metal nonabsorptive by closing down or plugging the pore structure of the anodized coating. For aluminum it is preferred that the surface of the metal layer is anodized or primed prior to contact with the polymer layer or prior to contact with a silane agent.

The surface of one or more of the metal layers which has an exterior face to the polymer layer may have a textured surface such as a hammered surface. The surface of the metal layer interior to the polymer layer (e.g., in contact with) may have a microstructure that facilitates bonding and increases delamination resistance between the metal and polymer layers. The metal layer may be provided with a supporting architecture such as, for example, ribs on the interior or exterior of the surface relative to the polymer surface to impart greater strength and/or rigidity to the finished metal/polymer laminate. In other embodiments, the exterior layer of the metal laminate may contain other decorative features or functional features such as, for example, patterning, paint or staining.

The metal layer may have a thickness in the range of from 0.008 to 0.50 inches, preferably from 0.010 to 0.20 inches and most preferably from 0.005 to 0.05 inches. The thickness may be such that the metal layer is a thick foil. It is preferable that the thickness of the metal layer is sufficient to resist impact, puncture and the oxidation which may occur over a 100 year life span of a building cladding material.

The core polymer layer or one or more interlayers may comprise or consist of thermoplastic and/or thermoset materials such as those described in “Polymer Handbook,” 4th edition, J. Brandrup, E. H. Immergut, E. A. Grulke, A. Abe, and D. R. Bloch, Eds., John Wiley & Sons; (2003) (incorporated herein by reference). Examples of polymers that may be used in the metal/polymer laminate include, for example, polyethylene, polypropylene, polybutene, polyvinyl chloride, polystyrene, polyamide, polyethylene terephthalate, polybutylene terephthalate and polycarbonate. Particularly preferred are thermoplastic and thermoelastomeric polymers and copolymers of ethylene and propylene with or without one or more co-monomers such as an alpha-olefin or a diene, especially preferred is high density polyethylene. Low density polyethylene (LDPE) and linear low-density polyethylene (LLDPE) may also be used and are preferred materials for the core polymer.

When a polymer interlayer is present it is especially preferred that the polymer interlayer comprise a polymeric material containing at least two, preferably three copolymerized monomer units. Adhesive polymer materials are preferred. For example, the polymer material of the polymer interlayer may be an olefin-based copolymer, for example, ethylene, propylene, butane, pentene and mixtures thereof, containing one or more additional saturated or unsaturated copolymerized hydrocarbon units, copolymerized with one or more acrylic ester monomer units, for example, methyl acrylate, ethyl acrylate and butyl acrylate, and/or one or more of the corresponding acids, together with a third, different monomer unit, for example maleic anhydride and glycidyl methacrylate. The polymerized monomer units may be present in a random fashion or present as blocks. The polymer of the interlayer may also contain copolymerized vinyl acetate units or vinyl acetate in place of the acrylic ester monomer. Ethylene vinyl acetate (EVA) copolymers are known to be useful in adhesive formulations and may be present as the only component, a major component or a minor component of the polymer interlayer. Ethylene acrylic ester copolymers may make up the polymer interlayer or may be present therein. Examples of ethylene acrylic ester copolymers include copolymers of an acrylic derivative, for example, butyl acrylate (EBA), methyl acrylate (EMA) or 2-ethyl hexyl acrylate (2HEA). The polymer of the polymer interlayer may also contain vinyl acetal and/or vinyl alcohol units. The polymer interlayer may be a film of a polyvinyl acetal or polyvinyl alcohol resin containing copolymerized vinyl acetate units. The polymer interlayer may contain one or more polymer components that comprise two or more of any of the afore-mentioned monomer units. The specific monomer make-up of the polymer interlayer may be selected to provide the desired balance of properties including water-fastness, tackiness, shear strength.

In a preferred embodiment the polymer interlayer comprises a polyolefin based film, for example polypropylene, polyethylene, polybutylene or a copolymer of any of ethylene, propylene or butane, most preferably the polymer interlayer comprises a linear low density polyethylene. The polyolefin may be subjected to grafting or compatibilizing with a monomeric, oligomeric or polymeric grafting or compatibilizing component. Grafting agents may include, for example, acryl monomers, acids thereof, esters thereof, and anhydrides thereof, and oligomers and polymers of the acryl monomer. The grafting treatment may result in an increase in the density of the polyolefin. The grafting may take place in the presence of an organofunctional silane. The silane may be incorporated within the resulting grafted polyolefin through chemical bonds or may be present as a mixture, blend or alloy of the grafted polyolefin. The grafting may take place in the absence of the organofunctional silane followed by addition of an organofunctional silane to the grafted polyolefin to provide a mixture of the grafted polyolefin and the organofunctional silane dispersed in the grafted polyolefin. Preferably, the organofunctional silane is present in an amount of less than 5 wt % based on the total amount of organofunctional silane and grafted polyolefin, and preferably is present in an amount of from 0.005 to 0.2 wt %, even more preferably from 0.01 to 0.05 wt %.

Thermoplastic films of polyester or a polymer containing polyamide units may also be used for the polymer interlayer.

The core polymer layer may be in the form of, for example, a dense flat polymer sheet, a polymer film (extruded or cast) or a foamed polymer. A foamed polymer may be prepared directly on the metal surface during lamination of the polymer layer to the metal layers.

The polymer layer contains a silane component which permits improved delamination resistance between the metal and polymer layers. The silane component is preferably a silane or a polysilane (e.g., polysiloxane) which contains Si—O and/or Si—R bonds. The silane may include silanes which have a silicon atom bonded to only carbon based or hydrocarbon substituents or may contain a mixture of silicon-carbon bonds and silicon-oxygen bonds. The silicon oxygen bonds preferably form a part of a silicon-oxygen-silicon backbone or even more preferably the oxygen is further bonded to a carbon based substituent to thereby form an alkoxy group.

The silane may include those materials known in the art as organofunctional silanes or silane coupling agents. The silane therefore includes compounds that contain a silicon atom core bonded to one or more alkoxy or hydrocarbon based substituents. The hydrocarbon based substituent may include functional groups that have one or more heteroatoms such as, for example, nitrogen, oxygen and sulfur. The heteroatom preferably forms part of a functional group such as, for example, an amine group, a thiol group, an unsaturated hydrocarbon group, a disulfide and an epoxide group.

Organofunctional silanes include, for example, 3-(trimethoxysilyl)propyl acrylate, methacryloxypropyltrimethoxysilane, tetraethoxysilane, allyltrimethoxysilane, vinyltrimethoxysilane, vinyltriethoxysilane, octyltriethoxysilane, methyltriethoxysilane, methyltrimethoxysilane, vinylmethyldimethoxysilane, β-(3,4-epoxycyclohexyl)ethyltrimethoxysilane, γ-glycidylpropyltrimethoxysilane, aminopropyltrimethoxysilane, aminopropylmethyldimethoxysilane, aminopropylmethyldiethoxysilane, aminoethylaminopropyltrimethoxysilane, aminoethylaminopropyltriethoxysilane. Organofunctional silanes are commercially available through suppliers such as Dow Corning Corporation (Midland, Mich.) and Degussa and include Z-6020, Z-6094, Z-6011, Z-6026, Z-6121, Z-6137, Z-6028, Z-6032, Z-6224, Z-6075, Z-6040, Z-6106, Z-6030, Z-6920, Z-6925, Z-6940, Z-6945, 1-6136, 9-6346, Q1-6083, Z-6070, 1-6366, 1-6321, Z-6265, Z-6403, Z-2306, Z-6124, Z-6341, Z-6595, and Z-6672.

The organofunctional silane may be copolymerized with the polymer material of one or more of the polymer-containing layers. Preferably the copolymerized silane is present in one or more of the polymer interlayers or adhesive layers. In the case of a polyolefin polymer, the organofunctional silane-containing copolymer may be prepared from a silane having a protected or unprotected organofunctional group and a copolymerizable group such as an unsaturated group (e.g., alkenyl or alkynyl group).

One preferred group silanes is represented by formula (I) below:
RₓSi(OR′)₄₋ₓ (I)

wherein the R groups may independently be an aliphatic hydrocarbon group, a hydrocarbon group substituted with one or more heteroatom-containing groups, most preferably R may be a hydrocarbon substituent substituted with one or more heteroatoms or heteroatom-containing groups,

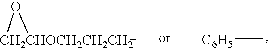

R′ is H— or C₁₋₁₀-alkyl, preferably C₁₋₈-alkyl, preferably C₁₋₆-alkyl, most preferably C₁₋₄-alkyl; and x is an integer of 1 to 4, preferably 1 to 3.

Heteroatom-containing silanes include silanes having a C₁₋₁₂-alkyl, preferably C₁₋₈-alkyl, preferably C₁₋₆-alkyl, most preferably C₁₋₄-alkyl group substituted with one or more nitrogen, sulfur or oxygen atoms or a combination of nitrogen, sulfur and oxygen atoms.

Another group of silanes may be of general formula (II). The silane of formula (II) may contain an ethylenically unsaturated group which may copolymerize with other ethylenically unsaturated monomers to provide a copolymer which contains copolymerized silane groups. The ethylenically unsaturated may also permit cross-linking with other monomers or unsaturated polymers.
R¹_{y}R²ₓSi(OR)_{4-x-y} (II)
wherein R₂ is a C₁₋₁₂-hydrocarbon group containing one or more heteroatoms, 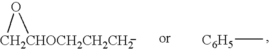
R³ is H—, C₁₋₄-alkyl;
R¹ is a C₁₋₁₂ alkyl group that may be ethylenically unsaturated;
x is an integer of 1 to 3; and
y is an integer of 0 to 2.

Specific examples of suitable organosilanes include glycidyloxypropyltrimethoxysilane; glycidyloxypropyltrimethoxysilane, which has been hydrolyzed or partially hydrolyzed with deionized water; phenoxytrimethoxysilane; and phenoxytrimethoxysilane, which has been hydrolyzed or partially hydrolyzed with deionized water. Good results have been achieved using partially hydrolyzed glycidyloxypropyltrimethoxysilane and unhydrolyzed phenoxytrimethoxysilane. The organosilane is suitably hydrolyzed by simply shaking the organosilane with 0.01 to 4 moles, preferably 0.025 to 1 moles, of water per moles or organosilane. Silanes and silicones are commercially available from Dow Corning Corp.

Particularly preferred organofunctional silanes may be of formula (I) wherein the R group contains one or more heteroatom-containing substitutents of the silicon atom is bonded to one or more heteroatoms. The heteroatom-containing substitutents may include one or more of an amino group, a thiol group, or a disulfide group. Examples of organofunctional silanes include aminopropyltriethoxysilane, aminopropyltrimethoxysilane, aminopropymethyldimethoxysilane, aminoethylaminopropyltrimethoxysilane, aminoethylaminopropyltriethoxysilane, aminoethylaminopropylmethyldimethoxysilane, diethylenetriaminopropyltrimethoxysilane, diethylenetriaminopropyltriethoxysilane, diethylenetriaminopropylmethyldimethoxysilane, diethylenetriaminopropylmethyldiethoxysilane, cyclohexylaminopropyltrimethoxysilane, hexanediaminomethyldiethoxysilane, anilinomethyltrimethoxysilane, anilinomethyltriethoxysilane, diethylaminomethyltriethoxysilane, diethylaminomethylmethyldiethoxysilane, methylaminopropyltrimethoxysilane, bis(triethoxysilylpropyl)tetrasulfide, bis(triethoxysilylpropyl)disulfide, mercaptopropyltrimethoxysilane, mercaptopropyltriethoxysilane, mercaptopropylmethyldimethoxysilane, 3-thiocyanatopropyltriethoxysilane, glycidoxypropyltrimethoxysilane, glycidoxypropyltriethoxysilane, glycidoxypropylmethyldiethoxysilane, glycidoxypropylmethyldimthoxysilane, methacryloxypropyltrimethoxysilane, methacryloxypropyltriethoxysilane, methacryloxypropylmethyldimethoxysilane, chloropropyltrichlorosilane, chloropropyltrimethoxysilane, chloropropyltriethoxysilane, chloropropylmethyldiethoxysilane, chloropropylmethyldimethoxysilane, chloropropylmethyldichlorosilane, tetramethoxysilane, tetraethoxysilane, tetrapropoxysilane, trimethoxysilane, triethoxysilane, methyltrimethoxysilane, methyltriethoxysilane, methyldiethoxysilane, methyldimethoxysilane, dimethyldimethoxysilane, dimethyldiethoxysilane, methyldichlorosilane, methyltrichlorosilane, trimethylchlorosilane, dimethyldichlorosilane, chloromethyltriethoxysilane, chloromethyltrimethoxysilane, dichloromethyltriethoxysilane, methyltris(methylethylketoxime)silane, methyltris(acetoxime)silane, dimethyldi(methylethylketoxime)silane, trimethyl(methylethylketoxime)silane, vinyltris(methylethylketoxime)silane, methylvinyldi(methylethylketoxime)silane, methylvinyldi(cyclohexanoneoxime)silane, phenyltris(methylethylketoxime)silane, tetramethyldivinyldisiloxane, tetramethyldivinyldisilazane, tetramethyldichloromethyldisiloxane, tertbutyldimethylchlorosilane, tertbutyldiphenylchlorosilane, methyltriacetoxysilane, tetraacetoxysilane, cyclohexylmethyldimethoxysilane, diisobutyldimethoxysilane, diisopropyldimethoxysilane, dicyclopentyldimethoxysilane, trimethylsilyl-1,2,3-triazole, 1-(trimethylsilyl)imidazole, and methacryloxypropyltris(trimethylsiloxy)silane.

In an embodiment of the invention the metal/polymer laminate contains a core polymer layer directly in contact with a least one surface of at least one of the metal layers. In one aspect of this embodiment of the invention, only one or no conventional adhesive-containing films are present between the polymer layer and the metal layer.

The silane may be present in the polymer core layer in an amount of up to 5 wt %. It is preferred that the silane is present in the core polymer layer in an amount less than or equal to 5 wt %. The silane may also be present in an amount of from 0.01 to 2 wt %, more preferably, 0.1 to 1 wt % and even more preferably from 0.2 to 0.50 wt %. Unless otherwise noted herein wt % is based on the amount of the silane as a percentage based on the total weight of the silane and the polymer.

In a particularly preferred embodiment of the invention the core polymer layer is free of silane and the silane is present only on the surface of the metal layers and the surface of the core polymer layer. In another preferred embodiment the silane is present in the polymer interlayer and not present in the core polymer layer or present in the core polymer layer in an amount not exceeding 0.01 wt % based on the total weight of the core polymer layer.

In another embodiment of the invention the metal polymer laminate may contain one or more silane-containing films (e.g., polymer interlayers) between the polymer layer and the metal layers. The silane-containing interlayer may comprise the same polymer as the core polymer layer or may comprise a different polymer than the core polymer layer. The silane-containing interlayer may be of thickness 10 to 100 μm thick, preferably 15 to 50 μm. The silane may be present in the polymer interlayer in an amount of greater than 50 ppm. In the polymer interlayer it is preferred that the silane may be present in an amount of ≦5 wt %. The silane may also be present in an amount of from 0.01 to 2.5 wt %, more preferably, 0.1 to 1.0 wt % and even more preferably from 0.2 to 0.50 wt %. Unless otherwise noted herein wt % is based on the amount of the silane as a percentage based on the total weight of the silane and the polymer. In a preferred embodiment the metal/polymer laminate consists of a core polymer layer in contact with two layers of a silane-containing polymer film layer, and the silane-containing film layers are in each contact with a separate metal layer. The core polymer layer may optionally contain the silane in addition to the polymer film interlayers.

In one of the preferred embodiments of the invention, the silane is present in one or more polymer interlayers and is chemically bonded to the polymer interlayer. For example, units of the silane may be copolymerized with other monomers which comprise the polymer interlayer. Thus the interlayer may be a polymer material having copolymerized units of an organofunctional silane monomer present within the chemical structure of the polymer. A plurality of the (co)polymerized silane monomer units may be present in the polymer interlayer, randomly distributed within the polymer structure or present as blocks.

Even a small amount of the silane copolymerized with the interlayer polymer can provide improvements in the adhesion of the polymer layer with the metal layer. When present as copolymerized units in the polymer interlayer, the silane may have a concentration of from 10 ppm to 1 wt % based on the total weight of the silane and the thermoplastic polymer layer. It is preferred that the copolymerized silane is present in the polymer interlayer in an amount of from 0.01 to 0.5 wt %. The silane may be present with other copolymerized monomer units such as polyethylene and/or polypropylene or any C₂-C₁₀, preferably C₂-C₆ mono or ethylenically unsaturated monomer. The silane may be present with other copolymerizable monomers such as dienes.

The silane may also be present in the polymer interlayer as a dispersion therein. The silane may be added to the polymer material during lamination (e.g., extrusion of the laminate) and thereby be present within the polymer matrix in a free form not covalently bonded to the polymer of the interlayer.

It is not necessary for any core polymer layer to comprise the silane before the polymer layer is laminated to the metal surfaces. The silane may be applied to the metal layers separately to form silane-coated metal layers. The placement of a polymer layer directly onto the silane-coated surface of the metal layer may provide sufficient dispersion of the silane to both the surface of the polymer layer and the metal layer. Preferably when the silane is directly applied to the metal surface to form a silane-coated metal surface, a polymer interlayer containing an adhesive and/or one or more silanes that are the same as or different from the silane coated onto the metal surface is present between the core polymer layer and the metal layer.

The silane may be applied to the surface of the metal layer as a solution in a solvent that is not reactive with the silane. The silane may also be applied to the surface of the metal layer as the neat liquid, paste, solid powder or melt. The solution or neat liquid may be applied by spraying the liquid onto the metal surface or by applying through a dispensing apparatus which controls the amount of silane deposited on to the metal surface.

In a further embodiment of the invention metal/polymer laminate, the polymer layer may contain components which may result in curing or crosslinking of the polymer during the process of adhering the polymer to the metal layers. Such a crosslinking process is described in U.S. Pat. No. 6,365,276 (incorporated herein by reference in its entirety). The presence of curing agents or catalysts within the polymer may serve to change the physical characteristics of the polymer which forms the polymer layer thereby improving such characteristics as rigidity, impact resistance, and thermal stability.

The inclusion of other components such as flame retardants and/or thermal stabilizers is included in the scope of the invention and may provide a means for imparting desirable characteristics to the metal/polymer laminate such as improved flame retardancy and a longer lifetime of the metal/polymer laminate under conditions of extreme temperature and/or environmental exposure.

Any of the polymer layers may contain other components such as reinforcing fibers and/or glass spheres and/or other mineral fillers to improve the chemical and mechanical resistance and physical characteristics of the metal/polymer laminate.

The silane-containing polymer layer can be prepared by conventional methods including coextrusion of the molten polymer with the silane component, incorporation of the silane component directly into the polymer molecular structure through, for example, grafting, or absorption of the neat silane.

The metal/polymer laminates may be prepared by pressing the polymer layer and the metal layer together with a sufficient force to adhere the metal and polymer layers with or without heat. The method described in U.S. Pat. No. 5,500,072 (incorporated herein by reference in its entirety) is a preferred process for preparing the invention metal/polymer laminates. In the preferred method of preparing the invention, a metal/polymer laminate is prepared by pressing at least two metal layers against a polymer layer in a manner similar to continuous extrusion whereby the metal layer and polymer layers are unwound from coils. In addition to pressing the metal and polymer layers together, the rollers may form structural features on either the metal or polymer layer to improve the rigidity and/or other physical characteristics of the resulting invention metal/polymer layer laminates.

In another embodiment of preparing the invention metal/polymer laminate, the polymer layer is extruded onto a moving surface of the metal layer. The extrusion may take place in the presence of foaming compounds incorporated within the polymer material thereby dispersing a hot, foamed polymer layer onto the metal layer surface. The resulting metal/polymer layer may then be covered by another metal layer pressed into the foamed polymer layer to provide the invention metal/polymer laminate.

A laminate of the present invention may be prepared by extruding the resin core through a die to form a flat sheet and passing the extruded resin sheet through laminating rollers simultaneously with two metal sheets, one on each surface of the resin sheet. At least one and sometimes both of the metal sheets are coated according to the present invention. Further, the sheets may have a layer of fluorinated ethylene vinyl ether polymer as a coating, as described in U.S. Pat. No. 6,365,276, the contents of which are hereby incorporated by reference.

Typically, the resin core is laminated at a temperature of 1100 to 190° F., preferably 125 to 165° F. It is preferred to extrude the resin sheet to a thickness which is larger than the gap between the laminating rollers by about 10%. Preferably, the coated metal sheet is preheated to a temperature of 320° to 420° F., most preferably 330 to 400° F. before passing through the laminating rollers with the resin core. The lamination is suitably carried out at a temperature of 320 to 410° F. Suitably, the laminating pressure is 250 to 1,100 psi, preferably 400 to 1000 psi.

### EXAMPLES

Metal/polymer laminates were prepared from two 12 ounce copper layers. The metal layers were laminated with two polymer interlayers containing an organofunctional silane. The metal/polymer laminate was prepared by heating and pressing the polymer layer and the metal layers together on a hot-press machine at a temperature of 300° F. and a pressure of 50 psi.

Test examples (e.g., Test Film RH6496-20) were prepared from a core layer of LDPE having a thickness of 3 mm. The core layer was separated from two metal layers of 12 ounce copper by two polymer interlayers having a thickness of 1-2 mil. The polymer interlayer contains an organofunctional silane. The copper layers were used as received from the foundry (Revere Foundry, Revere Mass.) and not treated prior to contact with the polymer interlayer. The conventional film examples were prepared in the same manner as the inventive examples however a film containing only a conventional adhesive was used in place of the silane-containing film.

The resistance of the resulting laminate to delamination was then measured by subjecting the laminates to a pull test from both sides of the laminate to determine the pull force needed to separate one side of the laminate. The metal polymer may delaminate by cohesive failure (e.g., tearing or destruction of the core polymer layer or one or more of the polymer interlayers) or by delamination. Delamination may occur when the metal layer shows signs of separation from the core polymer layer upon immersion in salt water. The resistance of the resulting laminate to delamination was then measured by subjecting the laminate to a 180° pull test on both sides of the laminate.

TABLE 1

| Days of immersion | Pull Results (Top/Bottom Skin) | |
|---|---|---|
| in salt water | Conventional Film | Test Film RH6496-20 |
| Fresh Pull Results | (19/20) Good cohesive | (23/30) Good cohesive |
| | failure | failure |
| 3 days 5% NaCl 50° F. | (20/27) some edge | (29/27) Good cohesive |
| | delamination seen | failure |
| 7 days 5% NaCl 50° F. | (23/20) some edge | (30/27) Good cohesive |
| | delamination seen | failure |
| 15 days 5% NaCl 50° F. | (5/18) severe edge | (28/30) Good cohesive |
| | delamination seen | failure |

Results for delamination resistance are shown above. Values indicate the pounds of pull required in order to separate the layers of the laminate.

The deterioration of the conventional film, as measured by the amount of pull in psi (pounds per square inch) to separate the metal layers from the core polymer layer, is greater than the deterioration of the invention laminate.

The salt water immersion test is a 90 day test where 1 inch by 6 inch strips of the test samples are immersed in a 5% weight by volume solution of NaCl at 50° C. for 90 days. Test strips are measured prior to immersion and at 3, 7, 15, 30, 60, 90 days after immersion. Typically the composites of conversion coated and primed aluminum and untreated zinc pass this test with no delamination observed. The copper using the standard adhesive film shows delamination creeping in from the edges as early as 3 days into the test and typically complete delamination is observed for at least one of the skins by 45 days.

The examples containing the silane-containing film delaminate only by cohesive failure indicating that the polymer layer is ripping or is otherwise destroyed indicating the strength of the metal-polymer bond is greater than the tear resistance of a polymer layer. Laminates containing the conventional adhesive film show separation of the metal and polymer layers through delamination at the metal-polymer interface.

Obviously, numerous modifications and variations of the present invention are possible in light of the above teachings. It is therefore to be understood that within the scope of the appended claims, the invention may be practiced otherwise than as specifically described herein.

1. A metal/polymer laminate comprising at least two metal layers and at least one core polymer layer between at least two metal layers, wherein the polymer layer comprises a thermoplastic polymer and at least one silane of formula (I):
R¹_{y}R²ₓSi(OR³′)_{4-x-y} (I)
wherein R² is a C₁₋₁₂-hydrocarbon group containing one or more atoms selected from the group consisting of N, S and O, 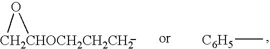
R³ is H—, C₁₋₄-alkyl;
R¹ is a C₁₋₁₂ alkyl group that may be ethylenically unsaturated;
x is an integer of 1 to 3; and
y is an integer of 0 to 2.

2. The metal/polymer laminate of claim 1, wherein the metal layer is copper.

3. The metal/polymer laminate of claim 1, wherein the metal layers are the same and are selected from the group consisting of copper, steel, aluminum, zinc and titanium, and the polymer layer comprises a polyethylene polymer.

4. The metal/polymer laminate of claim 1, wherein the polymer is a polyethylene.

5. The metal/polymer laminate of claim 1, wherein the thermoplastic polymer is selected from the group consisting of high density polyethylene, low density polyethylene, linear low density polyethylene, crosslinked polyethylene, and ultra high molecular weight polyethylene.

6. The metal/polymer laminate of claim 1, wherein the silane is chemically grafted to the polymer.

7. The metal/polymer laminate of claim 1, wherein the polymer is a foamed polymer.

8. The metal/polymer laminate of claim 1, consisting of a first metal layer, a polymer layer and a second metal layer.

9. The metal/polymer laminate of claim 1, consisting essentially of two metal layers and one polymer layer.

10. The metal/polymer laminate of claim 1, wherein the exterior surface of at least one of the metal layers is textured.

11. The metal/polymer laminate of claim 1, wherein the polymer layer is a composite further comprising a filler or reinforcing fiber.

12. A metal/polymer laminate comprising at least two metal layers, at least two adhesive interlayers and at least one core polymer layer between the adhesive interlayers, wherein at least en one of the core polymer layer or the adhesive interlayers comprise a thermoplastic polymer and a silane of formula (I):
R¹_{y}R²ₓSi(OR³)_{4-x-y} (I)
wherein R is a C₁₋₁₂-hydrocarbon group containing one or more atoms selected from the group consisting of N, S and O, 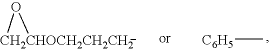
R³ is H—, C₁₋₄-alkyl;
R¹ is a C₁₋₁₂ alkyl group that may be ethylenically unsaturated;
x is an integer of 1 to 3; and
y is an integer of 0 to 2.

13. The metal/polymer laminate of claim 12, wherein the adhesive interlayers comprise ethylene.

14. The metal/polymer laminate of claim 12, wherein the metal layer is copper.

15. The metal/polymer laminate of claim 12, wherein the metal layers are the same and are selected from the group consisting of copper, steel, aluminum, zinc and titanium, and the polymer layer comprises a polyethylene polymer.

16. The metal/polymer laminate of claim 12, wherein the polymer is a polyethylene.

17. The metal/polymer laminate of claim 12, wherein the thermoplastic polymer is selected from the group consisting of high density polyethylene, low density polyethylene, linear low density polyethylene, crosslinked polyethylene, and ultra high molecular weight polyethylene.

18. The metal/polymer laminate of claim 12, wherein the adhesive interlayer comprises a thermoplastic polymer comprising a silane chemically grafted to the thermoplastic polymer of the adhesive interlayer.

19. The metal/polymer laminate of claim 12, wherein the polymer is a foamed polymer.

20. The metal/polymer laminate of claim 12, consisting of, in the following order, a first metal layer, a first adhesive interlayer, a core polymer layer, a second adhesive interlayer, and a second metal layer.

21. The metal/polymer laminate of claim 12, wherein the exterior surface of at least one of the metal layers is textured.

22. The metal/polymer laminate of claim 12, wherein one or more of the core polymer layer or the adhesive interlayers comprise a filler or a reinforcing fiber.

23. A metal/polymer laminate comprising at least two metal layers and at least one core polymer layer between at least two metal layers, and wherein a silane of formula (I) is present on the surface of the metal layers contacting the core polymer layer:
R¹_{y}R²ₓ(OR³)_{4-x-y} (I)
wherein R² is a C₁₋₁₂-hydrocarbon group containing one or more atoms selected from the group consisting of N, S and O, 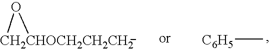
R³ is H—, C₁₋₄-alkyl;
R¹ is a C₁₋₁₂ alkyl group that may be ethylenically unsaturated;
x is an integer of 1 to 3; and
y is an integer of 0 to 2.

24. The metal/polymer laminate of claim 23, wherein the metal layer is copper.

25. The metal/polymer laminate of claim 23, wherein the metal layers are the same and are selected from the group consisting of copper, steel, aluminum, zinc and titanium, and the polymer layer comprises a polyethylene polymer.

26. The metal/polymer laminate of claim 23, wherein the polymer is a polyethylene.

27. The metal/polymer laminate of claim 23, wherein the thermoplastic polymer is selected from the group consisting of high density polyethylene, low density polyethylene, linear low density polyethylene, crosslinked polyethylene, and ultra high molecular weight polyethylene.

28. The metal/polymer laminate of claim 23, wherein the silane is chemically grafted to the polymer.

29. The metal/polymer laminate of claim 23, wherein the polymer is a foamed polymer.

30. The metal/polymer laminate of claim 23, consisting of a first metal layer, a polymer layer and a second metal layer.

31. The metal/polymer laminate of claim 23, consisting essentially of two metal layers and one polymer layer.

32. The metal/polymer laminate of claim 23, wherein the exterior surface of at least one of the metal layers is textured.

33. The metal/polymer laminate of claim 23, wherein the polymer layer is a composite further comprising a filler or reinforcing fiber.

34. The metal/polymer laminate of claim 23, wherein the metal/polymer laminate is obtained by applying the silane onto at least one surface of both metal layers to form silane-coated metal surfaces then contacting the silane coated metal surfaces with opposite sides of the core polymer layer.

35. The metal/polymer laminate of claim 23, further comprising at least two adhesive interlayers comprising a thermoplastic resin.

36. The metal/polymer laminate of claim 1, wherein the silane is not present in the core polymer layer.

37. The metal/polymer laminate of claim 1, obtained by applying the silane onto at least one surface of each metal layer to form a silane coated metal surface and contacting different surfaces of the core polymer layer with each of the silane coated metal surfaces.

38. The metal/polymer laminate of claim 1, wherein the metal layers are bonded to the core polymer layer through the silane.

39. The metal/polymer laminate of claim 12, wherein the silane is not present in the core polymer layer.

40. The metal/polymer laminate of claim 12, obtained by applying the silane onto at least one surface of each metal layer to form a silane coated metal surface and contacting different surfaces of the adhesive interlayers with each of the silane coated metal surfaces.

41. The metal/polymer laminate of claim 12, wherein the metal layers are bonded to the core polymer layer through the silane present in the adhesive interlayers.

42. The metal/polymer laminate of claim 12, wherein the silane is bonded to a metal layer and a polymer.

43. The metal/polymer laminate of claim 23, wherein the silane is not present in the core polymer layer.

44. The metal/polymer laminate of claim 23, wherein the silane is bonded to a metal layer and a polymer.
